(19) United States
(12) Patent Application Publication
(10) Pub. No.: US 2005/0154666 A1
(43) Pub. Date: Jul. 14, 2005

(54) Process for fixed income securities (Bonds) with a foreign exchange futures market hedge for international investors

(76) Inventor: Christopher Todd Angle, Redding, CT (US)

Correspondence Address: CHRISTOPHER ANGLE, 19 TOPLEDGE ROAD, REDDING, CT, 06896, US

(21) Appl. No.: 10/757,209

(22) Filed: Jan. 14, 2004

(51) Int. Cl. G06F 17/60

(52) U.S. Cl. 705/36

(57) ABSTRACT

A process for International Investors in Fixed Income Securities (Bonds) To Use A Futures Market Hedge To Reduce Foreign Exchange Risk. This method and utility is for international investors seeking the safety, liquidity, and income provided by bonds of U.S. origin, such as U.S. Treasury Notes, Bonds, Agency Notes, U.S. company bonds, debentures, et al, yet seek refuge from the foreign exchange risk of the U.S. dollar relative to the international investor's home currency. The method is accomplished by utilizing the futures market contracts or options on futures contracts available in the appropriate international currency on the various futures exchanges (e.g., on the NYBOT or CME).

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of fixed income investment by the international investor and more specifically to a process for reducing foreign exchange currency risk when overseas investors convert their local currency into U.S. dollars to invest in U.S. fixed income securities (bonds) by using a foreign exchange futures market hedge.

Foreign investors often come to the U.S. bond markets, especially the U.S. government bond market, seeking the interest return along with safety and liquidity. However, along with investing outside one's own home markets and entering the international market, in this case, the U.S. bond market, there comes a foreign exchange risk. That is, after the international investor converts his assets into the U.S. dollar, there develops the risk that the U.S. dollar could decline in value as noted in the various foreign exchange markets, such as the inter-bank market and the futures market. Should the U.S. dollar decline relative to the international investor's home currency, there develops a potential for a net loss to the investment if the maturity of the investment in the U.S. dollar declines more than the interest received by the international investor.

In order to mitigate this foreign exchange risk, the investor can turn to the futures market. When the investor purchases bonds in the U.S. market, he would go to one of the various futures exchanges to buy or sell the appropriate number of contracts (or options on contracts) in the appropriate currency (or if not available could substitute a general indicator/hedge vehicle, e.g., the U.S. Dollar Index) to establish a hedge against the relative strength of the two currencies.

Prior to this process international fixed income investors when concerned with foreign exchange risk would acquire forwards from their bankers in the Inter-Bank market. Forwards are comparatively expensive and illiquid. As a consequence, foreign investors will almost entirely forego the use of any foreign exchange risk hedge when investing in the U.S. fixed income bond market.

### BRIEF SUMMARY OF THE INVENTION

The primary object of the invention is that it allows foreign investors to purchase U.S. fixed income securities with reduced foreign exchange risk efficiently.

Another object of the invention is to provide a cost effective alternative to the forwards market of the Inter-Bank.

Third objective of the invention is to provide ease of changing investment plans which is accomplished through the liquidity available in the futures market.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for international investors in fixed income securities (bonds) to use a futures market hedge to reduce foreign exchange risk comprising the steps of: 1) establishing a futures (or options on a futures contracts) hedge position at a Futures Commission Merchant, and 2) establishing a margin arrangement between the broker-dealer of the bond securities and the FCM to cover the possible variation/margin call should the hedge lose value due to U.S. Dollar appreciation. The method uses the futures markets instead of the Inter-Bank to hedge the foreign exchange risk.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a flow chart of the operations that comprise the method.

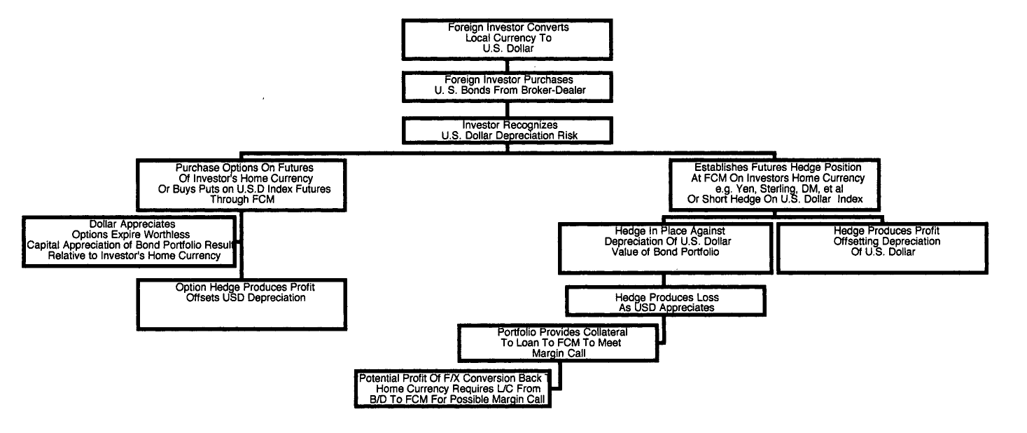

### DETAILED DESCRIPTION OF THE PREFERRED EMBODIMENTS

Detailed descriptions of the preferred embodiment are provided herein. It is to be under however, that the present invention may be embodied in forms. Therefore, specific details disclosed herein are not to be interpreted as limiting, but rather as a basis for the claims and as a representative basis for teaching one skilled in the art to employ the present invention in virtually any appropriately detailed system, structure or manner.

When international investors (we will use the example of Japanese investors who are typically known for their investment purchases in the U.S. Treasury Bond market) decide to convert from their local currency (in this case, yen) and invest in the fixed income (bond) market here using U.S. dollars, there exists a foreign exchange risk in that when converting back to yen the U.S. Dollar may have depreciated in the meantime versus the yen. Under the method of this patent application they would be able to hedge a significant amount of their yen/USD currency conversion risk upon their decision to convert back to Japanese yen at a later date by ether taking contract positions on Japanese yen contracts (or options on the contracts); or the investor may sell the appropriate number of contracts (or options on the contracts) of the U.S. Dollar Index to cover the amount of the investment.

To elucidate the process, when the investor, for example, buys a yen contract (or call option) on the Chicago Mercantile Exchange (CME), he is hedging against the possibility that the yen may appreciate against the U.S. dollar. When yen appreciates the value of the U.S. dollar denominated bond portfolio will go down relative to the yen; but correspondingly, the futures contracts (or options) will appreciate relative to the U.S. dollar. Also, if the vehicle of the U.S. Dollar Index (NYBOT) were used, the Japanese investor would sell the U.S. Dollar Index contras hedging the possibility of the dollar depreciation. The profit gained from the contract is offset by the depreciation of the U.S. dollar value of the bond portfolio relative to the yen.

Conversely, if the dollar appreciated with the depreciation hedge in place, there will be a loss generated by the hedge. This will be offset by the appreciation of the dollar value of the bonds relative to their value if sold and converted into yen.

In addition to futures contracts, options on futures contracts may be used to reduce the foreign exchange risk. Options can be used if the investor seeks, in addition to hedging the relate value of the currencies, to capture any potential additional profit should the U.S. dollar appreciate. If the investor took a position of options on a contract, it means that for the cost of the option the investor may exercise the option or not. This is most useful when the yen will depreciate against the U.S. dollar making his U.S. dollar denominated investment of bonds more valuable relative to the yen. Should he be holding futures contracts as a hedge, as the value of the yen goes down, so does the value of his position of the futures contacts off-setting the appreciation of the increase of the dollar value relative to the yen held within the bond portfolio. (This is the purpose and aim of the hedge.)

However, if a hedge were executed with options, the investor could just let the options expire worthless, and he is left with the appreciation of the U.S. dollar value of the bond porfolio which has appreciated against the yen if liquidated and converted into yen.

The negative point of the options is that there is a cost (the premium) associated with their purchase that is greater than the acquisition of the long/short position of futures contracts.

Hence, 1) the investor may choose either to acquire the obligations of outright positions to hedge the possible depreciation of the U.S. dollar at the costs associated with this action which are considered to be small compared to the interest that will be achieved when dealing with bond portfolios equal to or greater than $100,000 (most financial currency futures contracts are at the notional value of around $100,000 or greater); or 2) the investor may choose options with their greater cost (the premium) to capture any extra profit, should it occur, if the U.S. dollar appreciates.

3) There exists one more contingency (and its solution) for the investor: if the investor opts for the futures contract (instead of the up front expenses associated with options on futures) and the dollar appreciates against the investor's foreign currency (yen, in the present example), the bond portfolio, as stated previously, appreciates against the yen but the futures contact on the yen looses value as the investor hedged against the USD depreciation. As future contracts are marked to the market daily, the margin requirements to keep the contract in force must be met. This daily adjustment can be met by the holder of the bond securities at the broker-dealer establishing a letter of credit using the collateral of the bonds for the FCM (Futures Commission Merchant) where the contract positions are held.

4) Very possibly, the bonds are to be held longer than the term of the futures contract which typically can be traded out to one year (in some cases, a bit further) in advance. This will require that the futures contracts be closed out and again renewed for another year (or less, the financial instrument futures market trades typically March, June, September, December).

The requirements of the L/C, the closing and renewing of contracts, broker-dealer and FCM commissions, foreign exchange to/from the USD, and management fees will be met out of the principle and interest received of and from the bond portfolio.

The Advantages of this Process is that:

The futures market has great liquidity: the contracts are uniform and hence are bought and sold in the various exchanges such as the CME, NYBOT; this process avoids the illiquidity of the Inter-Bank market which ties one seller with one buyer through a defined contract specific to that buyer and seller of the currencies.

Because the contracts of the futures market are uniform, this process using the futures markets is less expensive to put in place than the specific contracts of the Inter-Bank where every contact is different and is negotiated by the intervening bank dealers.

This process will enable the international investor of bonds of approximately $100,000 or greater the advantage to invest in U.S. bonds which may hold greater interest yield and security of investment than the investor's home country financial products might offer with reduced foreign exchange currency risk.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A process for International Investors in Fixed Income Securities (Bonds) To Use A Futures Market Hedge To Reduce Foreign Exchange Risk comprising the steps of:
Foreign investor converts local currency to U.S. Dollar;
Foreign investor purchases U.S. bonds from a securities broker-dealer;
Investor recognizes the U.S. dollar depreciation risk;
The investor (using the collateral of his bond porfolio) establishes a futures hedge position at an FCM on the investors home currency, e.g. Japanese yen;
The hedge is put in place against the depreciation of the U.S. dollar value of the bond portfolio; and uses the Futures Markets instead of the Inter-Bank to hedge the foreign exchange risk.
